(19) United States
(12) Patent Application Publication
(10) Pub. No.: US 2024/0362299 A1
(43) Pub. Date: Oct. 31, 2024

(54) DATA PROCESSING METHOD AND DEVICE, AND ELECTRONIC DEVICE

(71) Applicant: Smarter Silicon (Shanghai) Technologies Co., Ltd., Shanghai (CN)

(72) Inventor: Yong CHEN, Shanghai (CN)

(21) Appl. No.: 18/643,451

(22) Filed: Apr. 23, 2024

(30) Foreign Application Priority Data
Apr. 28, 2023 (CN) 202310489139.6

(51) Int. Cl. G06F 17/16

(52) U.S. Cl. CPC G06F 17/16

(57) ABSTRACT

A data processing method includes obtaining at least one first target data object including first target data, the first target data in each first target data object at least including all valid data corresponding to each data processing channel, each first target data corresponding to corresponding position information, the position information indicating a position of second target data corresponding to the first target data, a number of first target data objects being less than a number of data processing channels; obtaining the corresponding second target data from to-be-processed data included in a second data object corresponding to each data processing channel based on the position information corresponding to the first target data; and performing data processing on the first target data and the corresponding second target data.

### CROSS-REFERENCES TO RELATED APPLICATION

This application claims priority to Chinese Patent Application No. 202310489139.6 filed on Apr. 28, 2023, the entire content of which is incorporated herein by reference.

### FIELD OF TECHNOLOGY

The present disclosure relates to the field of artificial intelligence technology and, more specifically, to a data processing method and device, and an electronic device.

### BACKGROUND

Neural network (NN) is a complex network system formed by a large number of simple processing units (neurons) that are interconnected. Currently, data processing based on neural network models has limitations such as high data storage and bandwidth requirements, and low computing performance. There is a need to improve the current data processing approach to overcome these limitations.

### SUMMARY

One aspect of this disclosure provides a data processing method. The method includes obtaining at least one first target data object including first target data, the first target data in each first target data object at least including all valid data corresponding to each data processing channel, each first target data corresponding to corresponding position information, the position information being used to indicate a position of second target data corresponding to the first target data, a number of first target data objects being less than a number of data processing channels; obtaining the corresponding second target data from to-be-processed data included in a second data object corresponding to each data processing channel based on the position information corresponding to the first target data; and performing data processing on the first target data and the corresponding second target data.

Another aspect of the present disclosure provides a data processing device. The device includes a first acquisition device, a second acquisition device, and a data processing device. The first acquisition device is configured to obtain at least one first target data object including first target data, the first target data in each first target data object at least including all valid data corresponding to each data processing channel, each first target data corresponding to corresponding position information, the position information being used to indicate a position of second target data corresponding to the first target data, a number of first target data objects being less than a number of data processing channels. The second acquisition device is configured to obtain the corresponding second target data from to-be-processed data included in a second data object corresponding to each data processing channel based on the position information corresponding to the first target data. The data processing is configured to perform data processing on the first target data and the corresponding second target data.

Another aspect of the present disclosure provides an electronic device. The electronic device includes a processor and a memory storing program instructions for, when executed by the processor, performing a data processing method. The method includes obtaining at least one first target data object including first target data, the first target data in each first target data object at least including all valid data corresponding to each data processing channel, each first target data corresponding to corresponding position information, the position information being used to indicate a position of second target data corresponding to the first target data, a number of first target data objects being less than a number of data processing channels; obtaining the corresponding second target data from to-be-processed data included in a second data object corresponding to each data processing channel based on the position information corresponding to the first target data; and performing data processing on the first target data and the corresponding second target data.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is an example of calculation volume comparison before and after valid data integration.

FIG. 2 is a flowchart of a data processing method according to an embodiment of the present disclosure.

FIG. 3 is a flowchart for forming a first target data object according to an embodiment of the present disclosure.

FIG. 4A is an example of a sparse weight matrix corresponding to each input channel according to an embodiment of the present disclosure.

FIG. 4B is a schematic diagram of valid data integration of the sparse weight matrix of FIG. 4A.

FIG. 5 is an example of evenly distributing to-be-processed data pairs formed by first target data and the corresponding second target data to different available hardware channels.

FIG. 6A and FIG. 6B are examples of calculation volume comparison before and

after valid data integration.

FIG. 7 is another flowchart for forming the first target data object according to an embodiment of the present disclosure.

FIG. 8 is an example of determining non-valuable data according to an embodiment of the present disclosure.

FIG. 9 is a hardware structural diagram of an electronic device suitable for the text recognition method according to an embodiment of the present disclosure.

FIG. 10 is a structural diagram of an electronic device according to an embodiment of the present disclosure.

### DETAILED DESCRIPTION

The technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

Currently, data processing based on neural network models has limitations such as high data storage and bandwidth requirements, and low computing performance.

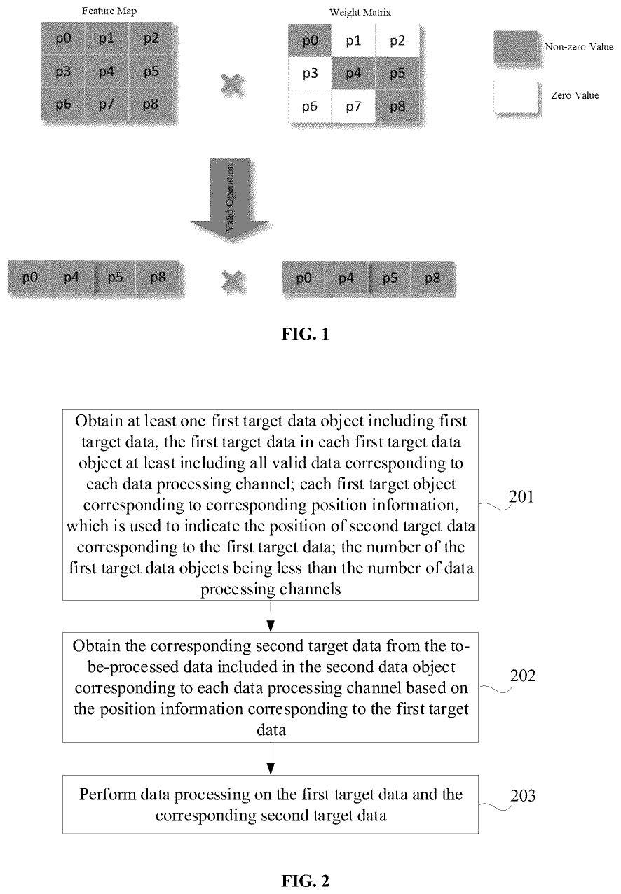

In neural network model training, weights are often quantized and pruned, resulting in a large number of 0 values in weights. The phenomenon of a large number of 0 values in the network is referred to as sparsificaion. In typical networks, such as LeNet-5, AlexNet, and VGG16, after pruning, a sparsity rate of more than 80% can generally be achieved without losing accuracy. The main operations in neural networks include multiplication and addition, and the 0 values do not contribute to the final calculation result. If the 0 values are compressed during transmission and storage and only valid values are transmitted, the bandwidth required for transmission and storage can be greatly reduced. If the 0 values are skipped during calculation, the calculation performance can be greatly improved. As shown in the example in FIG. 1, if the 0 values in the weight matrix are skipped, the calculation volume will be reduced from the original 9 to 4.

However, the relevant hardware currently responsible for data processing of neural network models, such as related commercial chips, does not support unstructured random sparse processing of weights. Zero-value weights are still involved in processing and take up computing time. Therefore, there is a need to improve the computing performance of data processing and reduce the data storage and bandwidth requirements based on the sparse characteristics of the weights in the model network.

Based on this, embodiments of the present disclosure provide a data processing method and device to improve the computing performance of data processing. The data processing method can be applied to, but is not limited to, electronic devices such as personal computers or servers. FIG. 2 is a flowchart of a data processing method according to an embodiment of the present disclosure. The method will be described in detail below.

201, obtaining at least one first target data object including first target data, the first target data in each first target data object at least including all valid data corresponding to each data processing channel; each first target object corresponding to corresponding position information, which is used to indicate the position of second target data corresponding to the first target data; the number of the first target data objects being less than the number of data processing channels.

The methods provided in the embodiments of the present disclosure can be, but are not limited to, applicable to natural language processing, image processing, video processing, speech recognition, industrial detection (such as equipment defect detection) and other fields.

The embodiments of the present disclosure mainly take the data processing of neural network models (such as deep neural network models) as an example for description.

Each data processing channel may be, but is not limited to, each input channel of the network layer in the neural network model. For example, for image processing based on a neural network model, each data processing channel may be the R, G and B three primary color input channels of each convolutional layer of the model, as well as texture input channels, semantic input channels, etc.

In its early formation stage, each data processing channel may correspond to a corresponding first data object in a one-to-one manner. Each first data object may include at least one valid data. In addition, each first data object may also include non-valid data (invalid data). Valid data in the data object may refer to data included in the data object that contributes to data processing. Data included in the data object that does not contribute to the data processing may be regarded as non-valid data or invalid data of the data object.

In the process at 201, the valid data corresponding to each data processing channel may refer to the valid data in the first data object corresponding to each data processing channel.

In order to improve the data processing performance of each data processing channel, the valid data in the first data objects corresponding to each data processing channel may be integrated in advance to obtain at least one first target data object. The at least one first target data object may at least include all valid data in each first data object corresponding to each data processing channel, and the number of the first target data objects may be less than the number of data processing channels. Accordingly, at least part of the invalid data in each first data object can be pruned or compressed. The data in the first target data object may be referred to as the first target data. The first target data may be valid data or invalid data, which can be set based on actual needs.

At the same time, corresponding position information may be recorded for the first target data in the first target data object. The position information of the first target data may be used to indicate the position of the second target data corresponding to the first target data.

In the data processing for each data processing channel, each data processing channel may also correspond to a to-be-processed second data object. The data in the first data object and the second data object corresponding to the same data processing channel may correspond to to-be-processed data pairs based on the position in a one-to-one manner. The second target data corresponding to the first target data in the first target data object may be the second target data corresponding to the first target data as the to-be-processed data pair in the second data object corresponding to the channel to which the first target data object belongs.

In some embodiments, the position information of the first target data may indicate the corresponding data processing channel and the corresponding position within the indicated data processing channel. The indicated data processing channel may be the data processing channel corresponding to the first target data object to which the first target data belongs. The corresponding position in the indicated data processing channel may be the position of the first target data in the corresponding first target data object.

In other embodiments, the position information of the first target data may also indicate the first target data object to which the first target data belongs and its position in the first target data object to which it belongs in order to determine the corresponding data processing channel based on the first target data object to which it belongs, determine the second data object corresponding to the channel, and based on the position of the first target data in the first target data object to which it belongs, further determine the second target data that matches the first target data in the determined second data object that is used to form the to-be-processed data pair.

Take the neural network model as an example. When the model training in the model training phase is completed, each input channel may correspond to a weight matrix (a convolution kernel). When the training is completed, the weight matrix corresponding to the input channel may be used as the first data object of the input channel, where non-zero values included in the weight matrix may represent valid data, and the zero values may represent invalid data. The second data object corresponding to the input channel may be the to-be-processed feature map on the input channel during the model usage phase. In the embodiments of the present disclosure, after completing the model training, the non-zero values in the weight matrices on each input channel of the model network layer may be integrated to crop out at least part of the zero-value data to obtain at least one corresponding target weight matrix (the first target data object). After integration, the number of target weight matrices corresponding to the network layer may be less than the number of input channels in the network layer, and each weight in the target weight matrix may be referred to as a target weight.

At the same time, the corresponding position information may be recorded for the target weight in the target weight matrix. In some embodiments, the position information of the target weight may indicate the input channel corresponding to the original weight matrix to which the target weight belongs and the corresponding position within the indicated input channel (the corresponding in the indicated input channel is substantially the position of the target weight in the original weight matrix to which the target weight belongs), or the position information may also indicate the original weight matrix to which the target weight belongs and its position in the original weight matrix.

In some embodiments, the feature maps may be various types of processed data such as images and voices. More specifically, the feature map may be subjected to one-dimensional convolution, two-dimensional convolution, or three-dimensional convolution, which is not limited in the embodiments of the present disclosure. For example, for a one-dimensional convolution kernel of the size of 1*3, one-dimensional convolution can be performed on the 1*3 feature map based on a 1*3 weight matrix, for a two-dimensional convolution kernel of the size of 3*3, two-dimensional convolution can be performed on the 3*3 feature map based on the 3*3 weight matrix.

When performing data processing for each data processing channel, the at least one first target data object corresponding to each data processing channel may be obtained first. For example, at least one target weight matrix corresponding to each input channel of the current network layer in the neural network model may be obtained. The network layer may be a convolutional layer or a fully connected layer in the model network.

202, obtaining the corresponding second target data from the to-be-processed data included in the second data object corresponding to each data processing channel based on the position information corresponding to the first target data.

Subsequently, for each first target data object, the corresponding second target data may be obtained from the to-be-processed data included in the second data object corresponding to each data processing channel based on the position information corresponding to the first target data to form the corresponding to-be-processed data pair with the first target data.

For the former implementation method for the position information of the first target data, for each first target data in each first target data object, the to-be-processed data corresponding to the target position in the second data object corresponding to the target data processing channel may be obtained as the second target data corresponding to the first target data. The target data processing channel and the target position may be respectively the data processing channel indicated by the position information of the first target data and the corresponding position within the indicated data processing channel.

For the latter implementation method for the position information of the first target data, for each first target data in each first target data object, the first data object to which the first target data belongs may be determined based on its position information, and from the second data object corresponding to the data processing channel where the first data object belongs, data consistent with the position of the first target data in the first data object to which it belongs may be obtained as the second target data to form the to-be-processed data pair with the first target data.

For example, assume that the convolutional layer of the neural model corresponds to three input channels Ch1, Ch2, and Ch3, which correspond to the weight matrices Wm1, Wm2, and Wm3 respectively when the model training is completed. After integrating the non-zero weights in the weight matrices Wm1, Wm2, and Wm3, the target weight matrix Wm0 can be obtained. In the data processing stage, the to-be-processed feature maps corresponding to the three input channels Ch1, Ch2, and Ch3 may be Fm1, Fm2, and Fm3 respectively. For each target weight in Wm0, the feature value in the corresponding feature map may be obtained. For example, assume that a certain target weight in the 3*3 target weight matrix Wm0 belongs to the original weight matrix Wm1 and is located at position 6 in the 3*3 matrix Wm1 (a total of 9 positions 1, 2, . . . , 9 can be set in the 3*3 matrix, and each position can be arranged in sequence in the matrix). Based on the position information (Wm1, 6) of the target weight, channel Ch1 may be determined, then the feature map Fm1 corresponding to channel Ch1 may be determined. Subsequently, the feature value corresponding to position 6 may be obtained from Fm1 to form the to-be-processed data pair with the target weight.

203, performing data processing on the first target data and the corresponding second target data.

Subsequently, data processing can be performed on the first target data and the second target data in each to-be-processed data pair to obtain the data processing result of the to-be-processed data pair. In addition, on-demand processing can also be performed on the corresponding data processing results of each to-be-processed data pair.

In some embodiments, the processing method of the first target data and the second target data in the to-be-processed data pair, and/or the processing method of the data processing results corresponding to each to-be-processed data pair may be determined based on business needs. The determined processing method may include at least one of multiplication processing and addition processing.

Take the data processing of neural network models as an example. Multiplication and addition processing may be performed on each to-be-processed data pair (the target weight-feature value) formed based on the target weight matrix and the feature map. That is, the target weight and the feature value in each to-be-processed data pair can be multiplied separately, and then the corresponding multiplication results of each to-be-processed data pair may be added. For example, after performing multiplication and addition processing on two “target weight-feature value” data pairs B-b and E-e, B*b+E*e can be obtained.

Consistent with the present disclosure, by integrating the valid data in the first data objects corresponding to each data processing channel into at least one first target data object, the number of first target data objects can be smaller than the number of data processing channels, thereby realizing the pruning and compression of at least part of the invalid data in the first data object corresponding to each data processing channel. Correspondingly, during data processing of each data processing channel, the transmission, storage, and operation of at least some invalid data can be skipped, thereby improving data computing performance and reducing data storage and bandwidth requirements. In addition, since pruning is performed on invalid data that does not contribute to data processing, the data processing results will not be affected.

In some embodiments, the sparsity of each first target data object may be less than a set threshold, the sparsity being used to character the proportion of invalid data in the first target data object.

For example, in valid data integration processing, the integration processing process may be limited based on constraints such that the sparsity of each target weight matrix is less than 10%, and the proportion of zero-value weights in the target weight matrix is controlled within 10%.

By limiting the sparsity of the first target data object, the proportion of invalid data in the first target data object can be less than the set threshold such that the sparsity can be set as small as possible, which correspondingly ensures that enough invalid data is pruned out on each data processing channel as much as possible. Accordingly, the data computing performance of each data processing channel is further improved, and the data storage and bandwidth requirements are further reduced.

In some embodiments, the constraints on the sparsity value may also be appropriately relaxed. More specifically, a certain margin may be provided for the sparsity setting based on the set threshold, and the sparsity value may be adjusted within this margin range. Accordingly, enough invalid data in each data processing channel can be pruned as much as possible, and the complexity of integration processing can also be appropriately reduced.

In addition, compared with some technical solutions that directly conduct model training through constraints to control the sparsity of the weight matrix of the model network based on the training process, in the present disclosure, through valid data integration after training, the control of the sparsity of the weight matrix based on constraints during the model training process can be replaced, thereby reducing the limitation on the model training process, reducing the complexity of model training, and ensuring the data processing effect of the trained model.

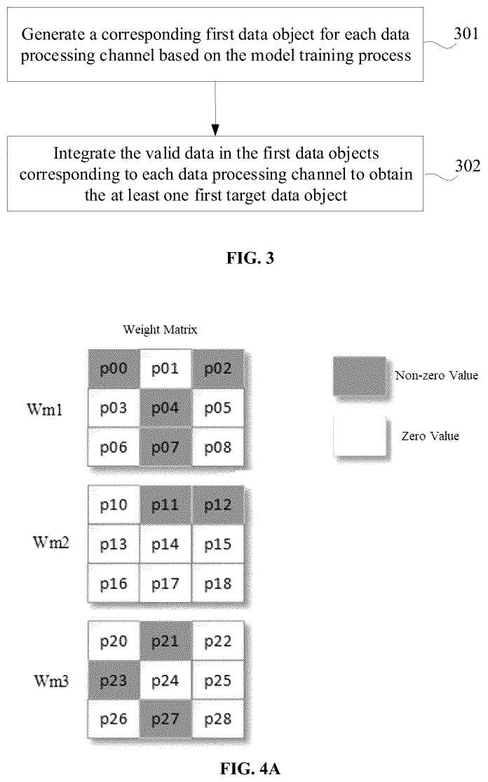

FIG. 3 is a flowchart for forming a first target data object according to an embodiment of the present disclosure. The method will be described in detail below.

301, generating a corresponding first data object for each data processing channel based on the model training process.

In some embodiments, the model training process based on the neural network model may generate a corresponding weight matrix for each input channel of the network layer in the model network as the first data object of the input channel. For example, based on the training process of the deep neural network model a corresponding weight matrix can be generated for the input channels corresponding to each convolutional layer in the model.

302, integrating the valid data in the first data objects corresponding to each data processing channel to obtain at least one first target data object.

Subsequently, integration may be performed on valid data in the first data objects corresponding to each data processing channel, and at least part of the invalid data may be pruned therein to obtain the at least one corresponding first target data object.

More specifically, the invalid data and valid data in the first data object corresponding to each data processing channel may be determined. The valid data included in some first data objects may be migrated to the position of the invalid data in the first data objects other than the first data objects including the valid data to realize the integration of valid data in the first data object corresponding to each data processing channel. The at least one first target data object may include the first data object that includes at least each valid data obtained after the migration is completed.

In addition, during migration, in some embodiments, the invalid data in the first data objects other than the first data objects including the valid data may be first cleared to free up the position occupied by the invalid data in the corresponding first data object. Based on this, the valid data included in the first data objects may be migrated to the position corresponding to the invalid data in the first data object other than the first data objects including the valid data. In some embodiments, after clearing the corresponding invalid data to make the position occupied by the invalid data available, the valid data in the first data objects in the first data objects from which the invalid data has been cleared may be rearranged. Accordingly, each valid data can be arranged adjacently in the first data object, leaving vacant positions connected in sequence to facilitate the migration of valid data therein.

However, the embodiments of the present disclosure are not limited thereto. In some embodiments, when the invalid data clearing has not been performed, the valid data included in some first data objects may be directly migrated to the position of the invalid data in the first data objects other than the first data object including the valid data to overwrite the original invalid data at the migrated position.

The valid data integration described above based on migration processing can be used as an additional processing step in the model training phase, and can be executed directly after the first data object of each data processing channel is obtained based on the model training process, such as after obtaining the weight matrix of each input channel of the model convolution layer through model training and executed in real time. Accordingly, the neural network model obtained after final training can be provided at its network layer by integrating the at least one first target data objects (the target weight matrix) whose number is less than the number of input channels, rather than the first data objects whose number is equal to the number of input channels (based on the original weight matrix of each input channel obtained from model training), and the position information corresponding to the first target data in each first target data object can be recorded.

Alternatively, in some embodiments, the valid data based on the migration processing described above may also be integrated as preprocessing in the model usage phase. Before using the model for data processing, valid data integration may be first performed based on migration processing on the first data objects corresponding to each input channel of the model network layer to obtain the at least one first target data object corresponding to the network layer, and to record the position information corresponding to the first target data in each first target data object at the same time.

The following is an application example.

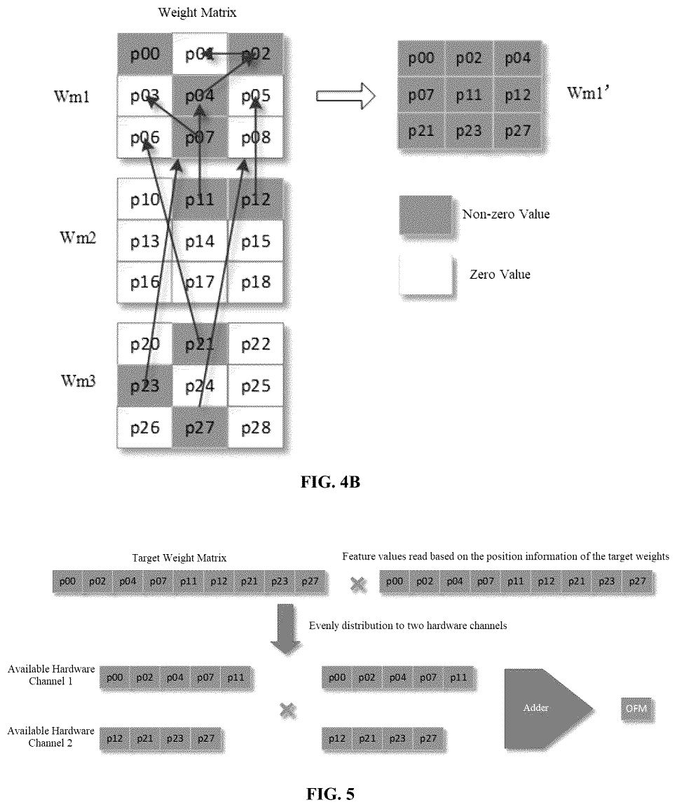

In this example, after training, the convolutional layer of the neural network model includes three input channels Ch1, Ch2, and Ch3, corresponding to three sparse convolution kernel weight matrices, such as the 3*3 matrices Wm1, Wm2, and Wm3 shown in FIG. 4A. There is a total of 9 non-zero weight values in the three sparse weight matrices Wm1, Wm2, and Wm3. The zero values in Wm1 can be removed through software, the non-zero weights can be moved and re-arranged to leave free positions connected to each other. Then the non-zero weights in Wm2 and Wm3 can be moved to the corresponding free positions in Wm1, see FIG. 4B for details. In FIG. 4B, the arrows represent the movements/migrations of data. More specifically, the data at the tail position of the arrow is moved to the position indicated by the arrow, thereby forming a new dense non-zero weight matrix Wm1′. Since the non-zero weights in the weight matrices Wm2 and Wm3 on channels Ch2 and Ch3 are moved to the weight matrix Wm1 of channel Ch1 to form the dense matrix Wm1′, the resulting dense matrix Wm1′ is located in channel Ch1, and the remaining two channels Ch2 and Ch3 form idle channels that do not include non-zero weights. It should be easy to understand that Wm1′ essentially includes the non-zero weights on the three channels of Ch1, Ch2, and Ch3, such that in practical sense, Wm1′ corresponds to these three channels.

At the same time, the position information corresponding to each non-zero weight in Wm1′ before integration can be recorded. For example, the position information corresponding to P12 before integration can be (Ch2, 3), which is used to indicate the corresponding input channel Ch2 and position 3 in the channel before integration, such that the feature value at position 3 can be selected from the feature map corresponding to Ch2 to form the corresponding data pair with P12 based on the position information. Alternatively, the position information may also be recorded as (Wm2, 3). Based on this position information, the input channel Ch2 can first be determined based on the corresponding relationship between the weight matrix and the input channel, then the feature value at position 3 can be selected from the feature map corresponding to Ch2 to form the corresponding data pair with P12.

The integration of valid data in the first data object corresponding to each data processing channel can be realized through software. There is no need to change the model structure of the existing neural network model as long as valid data integration is performed on the weight matrices of each network layer of the model and the relevant information is recorded before using the model, which is easy to implement, suitable for all neural network models, and the hardware is unaware of the integration process. There is no need to change the hardware structure, which is easy to deploy and has low implementation difficulty.

In some embodiments, before forming the first target data object, whether the data in the first data object corresponding to each data processing channel meets a sparsification condition may also be determined. When the sparsification condition is met, the process of integrating the valid data in the first data objects corresponding to each data processing channel to obtain at least one first target data object may be triggered.

The sparsification condition may be set to any of the following conditions.

Condition 1: the total proportion of invalid data in each first data object corresponding to each data processing channel reaches a preset proportion.

The total proportion may refer to the ratio between the total amount of invalid data in each first data object and the total amount of data included in each first data object.

Condition 2: the proportion of invalid data in the first data object corresponding to each data processing channel in the corresponding first data object reaches the preset proportion.

Condition 3: the proportion of invalid data in the first data object corresponding to each data processing channel in the corresponding first data object reaches the preset proportion, and the total proportion of invalid data in each first data object corresponding to each data processing channel reaches the preset proportion.

If the sparsification condition is not met, the integration processing of valid data on each data channel may not be performed, and the original first data object of each data processing channel may be retained, such as retaining the original convolution kernel weight of each input channel in the network layer of the neural network model.

In the embodiments of the present disclosure, by performing the channel data detection based on sparsification condition described above, and only performing the integration processing of valid data on each data processing channel when the sparsification condition is met, meaningless integration when data on the channel is dense can be avoided to avoid invalid processing.

In some embodiments, the process at 203, performing data processing on the first target data and the corresponding second target data, may be further implemented through any of the following processes.

11) assigning a corresponding available hardware processing channel to each first target data object, and using the corresponding available hardware processing channel to perform data processing on the first target data and the corresponding second target data in the corresponding first target data object.

The available hardware processing channel may be a currently unoccupied hardware computing channel that can be scheduled to perform the required operations on the to-be-processed, such as a computing channel based on arithmetic units and registers. Each channel may include as many arithmetic units and registers as required, and may also include other required hardware. In addition, for data processing of neural network models, the available hardware processing channel may be the core hardware unit Tensor core corresponding to the neural network processor (NPU).

In the implementation process of 11), each first target data object may be allocated to an available hardware processing channel based on the first target data object, and the available hardware processing channel may be used to perform data processing on the first target data and the corresponding second target data in the allocated first target data object.

For example, Tensor core may be used to perform multiplication and addition processing on the “target weight-feature value” data pairs corresponding to each target weight in the assigned target weight matrix. That is, the target weight and the feature value in each data pair may be multiplied first, then the corresponding multiplication results of each data pair may be added.

12) based on a preset balancing strategy, evenly distributing the to-be-processed data pairs formed by each first target data and the corresponding second target data to different available hardware processing channels based on the quantity, and using the corresponding available hardware processing channels to perform data processing on the allocated to-be-processed data pairs.

In the implementation process of 11), a balancing strategy that can be used to evenly distribute each to-be-processed data pair to different available hardware processing channels based on quantity may be set in advance.

In some embodiments, the balancing strategy may be set as: the absolute value of the difference in the number of to-be-processed data pairs allocated on different available hardware processing channels being less than a set value.

Correspondingly, based on the balancing strategy, the to-be-processed data pairs formed by each first target data and the corresponding second target data may be allocated to different available hardware processing channels based on the number of to-be-processed data pairs form by each first target data and the corresponding second target data, and the number of currently available hardware processing channels. Accordingly, the number of to-be-processed data pairs allocated to each available hardware processing channel can be relatively balanced, the absolute value of the quantity difference can be less than the set value, and different available hardware processing channels can process the allocated data in parallel.

As shown in the example of FIG. 5, the non-zero value dense weight matrix (i.e., the target weight matrix) obtained after integration includes a total of 9 non-zero weights. For each non-zero weight, the NPU reads the corresponding feature value from the feature map corresponding to each input channel based on its position information to form the to-be-processed data pair, and obtains 9 feature values, which corresponds to the 9 non-zero weights in order, forming 9 to-be-processed data pairs accordingly. Assume that there are currently two available hardware channels: available hardware channel one and available hardware channel two. If there are two available Tensor core, the 9 to-be-processed data pairs may be divided into two groups based on the balancing strategy. The first group may include the first 5 the to-be-processed data pairs corresponding to the first 5 non-zero weights, and the second group may include the to-be-processed data pairs corresponding to the last 4 non-zero weights, and the two groups of to-be-processed data pairs may be allocated to two different available hardware channels, as shown in FIG. 5. Subsequently, the processing results of each channel may be added in the adder to obtain the output feature map (OFM in FIG. 5).

After evenly distributing the 9 effective weights and their corresponding feature values to the two channels, the valid data amounts of the two channels are 5 and 4 respectively. In this case, the hardware channel such as Tensor core can be informed that the current network kernel size is 5*1. Accordingly, the weight of each channel of the hardware can be configured to 5, and the two channels can perform calculation in parallel. After a total of 5 cycles, the final calculation result can be obtained. The original network needs to go through two rounds of calculations. The first round of calculation uses two channels, and the second round of calculation uses one channel (original uncompressed three 3*3 matrices, a total of 27 weights, the first round uses two channels to process two weight matrices and corresponding feature maps in parallel, which requires 9 cycles; the second round uses one channel to process the remaining weight matrix and the corresponding feature map, which requires 9 cycles). That is, a total of 9×2=18 cycles are required. Therefore, after the balanced distribution of hardware channel data, the calculation time is reduced from the original 18 time units to 5.

In some embodiments, after valid data integration of the first data objects corresponding to each data processing channel to obtain at least one first target data object, relative to the number of first target data objects, the redundant idle data processing channels formed can be trimmed. Subsequently when reading the data of the second data object, indexing to the corresponding second target data in each second data object can be realized based on the position information of the first target data in the first target data object, and the first target data and the corresponding second target data can form a valid data pair to be sent to the available hardware channel for calculation and processing. The available hardware channels are unaware of the valid data integration and channel trimming. More specifically, the obtained effect data pairs corresponding to the same first target data object can be used as data pairs on one data processing channel to perform the corresponding operations.

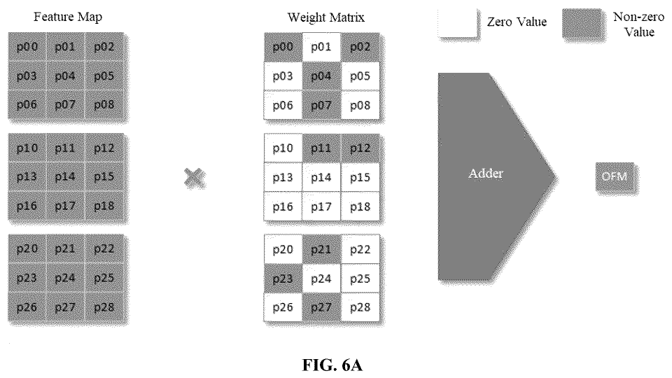

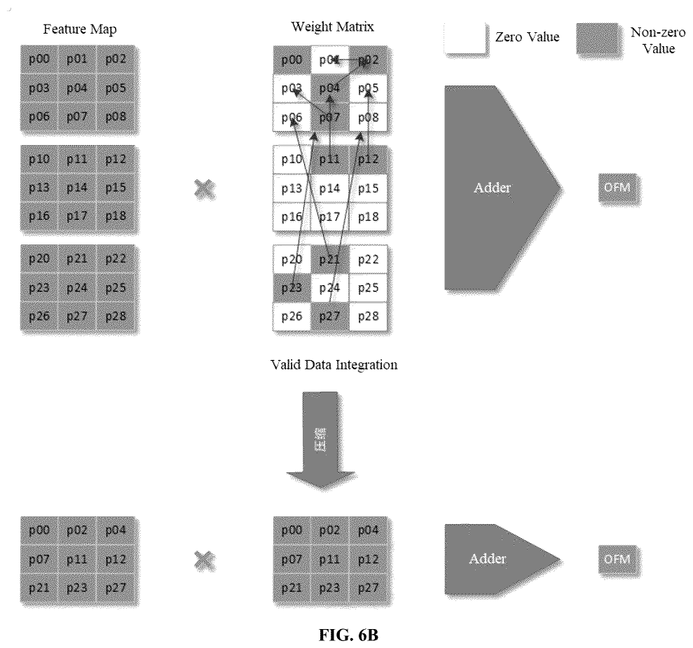

For example, in the examples shown in FIG. 4A and FIG. 4B, after the integration is completed, the weight matrix Wm1′ is located in the input channel Ch1, forming a dense network with only one channel Ch1, correspondingly producing two redundant invalid channels Ch2 and Ch3, therefore, Ch2 and Ch3 can be cut out. When the network information is sent to the available hardware channels, the hardware is informed that the network of this model is a dense weight network with only one channel, and the NPU is notified with the position of each weight in the dense weight matrix Wm1′ in the original network. When the NPU reads the feature map data, the NPU only needs to read the feature value matching the weight position based on the weight position index to form a valid data pair. Further, the NPU sends the Wm1′ and its matching feature values to the Tensor core for calculation, such as convolution calculation. The Tensor core is not aware of the valid data integration and channel trimming, and treats the network as an ordinary dense network with one channel. At the same time, the calculated output data is indexed based on the weight position of the next layer network, and only valid data is stored. The total calculation time is reduced from the original 27 time units to 9 time units. For details, reference can be made to FIG. 6A and FIG. 6B.

In some embodiments, the cutting of idle data processing channels may refer to the cutting from the software level, rather than actually cutting out the corresponding idle data processing channels from the network structure of the model. That is, for the first target data object to be allocated to the available hardware processing channel, the software may only record the relevant information of the channel where the first target data object is located, such as Ch1 where Wm1′ is located. Further, the software may no longer record channels that are idle relative to the first target data object, such as Ch2 and Ch3 described above.

For the idle data processing channels formed after integration, pruning (clipping at the software level) may not be performed as long as the number of model network layer channels perceived by the available hardware channels is the number of the first target data objects.

By integrating the valid data in the first data objects corresponding to each data processing channel into at least one first target data object, the number of first target data objects can be smaller than the number of data processing channels, thereby realizing the pruning and compression of at least part of the invalid data in the first data object corresponding to each data processing channel. Correspondingly, during data processing of each data processing channel, the transmission, storage, and operation of at least some invalid data can be skipped, thereby improving data computing performance and reducing data storage and bandwidth requirements. At the same time, processing hardware such as valid data integration is agnostic, and there is no need to make any adjustments to the hardware structure.

In some embodiments, the processing method provided by the embodiments of the present disclosure may include performing data processing on the first target data and the second target data corresponding to a plurality of preset functional layers. Each functional layer may correspond to multiple data processing channels, and each functional layer may correspond to at least one to-be-processed first target data object, and a second data object on each corresponding data processing channel. Each functional layer may be connected in series.

Take data processing of neural network models as an example. The plurality of functional layers may be the plurality of convolutional layers of the model network. Each convolutional layer may correspond to multiple input channels, and correspond to at least one to-be-processed target weight matrix (a dense matrix including at least effective weights obtained after effective weight integration) and a feature map on each corresponding input channel. The first target data and the second target data may be respectively the target weight in the target weight matrix obtained after integration and the feature value in the feature map that matches the target weight position to from a valid data pair.

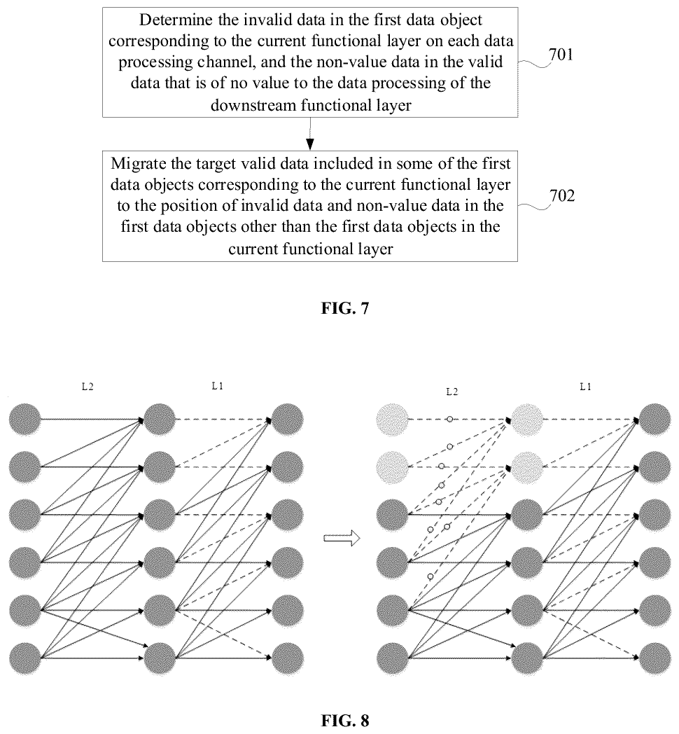

Based on this, refer to FIG. 7, which is another flowchart for forming the first target data object according to an embodiment of the present disclosure. As shown in FIG. 7, integrating valid data in the first data objects corresponding to each data processing channel to form at least one first target data object may include the following processes.

701, determining the invalid data in the first data object corresponding to the current functional layer on each data processing channel, and the non-valuable data in the valid data that is of no value to the data processing of the downstream functional layer.

More specifically, if there is a first data object including invalid data in each first data object corresponding to the first functional layer in the plurality of functional layers, the to-be-processed data whose corresponding data processing results will be invalidated by the invalid data may be determined from each first data object corresponding to the upstream functional layer of the first functional layer as non-valuable data.

It should be noted that certain data in each first data object corresponding to the upstream functional layer being invalidated by the invalid data of its downstream function layer may be that for the data does not contribute to the data operations of the downstream functional layer, all operations the data participates in will be invalidated by the corresponding invalid data of the downstream functional layer.

Refer to the example shown in FIG. 8. Each column of nodes in FIG. 8 corresponds to a convolutional layer of the neural network model and represents the output of the convolutional layer. The two adjacent columns of nodes on the left and right correspond to the convolutional layers respectively, forming an upstream and downstream relationship. The output of the previous convolutional layer is the input of the next convolutional layer. The lines in FIG. 8 represent weights, where the solid lines represent non-zero weights, and the dotted lines without circle marks represent zero-value weights. If a certain layer in the network is sparse, that is, a certain convolutional layer has a zero-value weight, the process can continue to trace back to the previous layer to determine the weight in the previous layer that will be invalidated by the zero-value weight of the layer. As shown in FIG. 8, layer L1 includes multiple zero-value weights (dotted lines without circles). The 8 non-zero weights in the upstream layer L2 corresponding to layer L1 (the 8 dotted lines with circles in L2) are all 0 in L1, and all operations these 8 non-zero weights participate in will be invalidated by the corresponding zero-value weights in L1, thereby identifying the 8 non-zero weights in L2 (the 8 dotted lines with circles in L2) as non-valuable data. As for the weights other than the 8 dotted lines with circles in L2, since they all have corresponding non-zero weights in L1, at least part of the operations they participate in will not be invalidated by the zero-value weights in L1, thereby not being identified as non-valuable data.

702, migrating the target valid data included in some of the first data objects corresponding to the current functional layer to the position of invalid data and non-valuable data in the first data objects other than the first data objects in the current functional layer.

In some embodiments, the at least one first target data object corresponding to the current functional layer may include a first data object obtained after completing the migration of the current functional layer and at least including each valid data. The target valid data included in the first data object may be data other than invalid data and non-valuable data in the first data object.

Subsequently, in the valid data integration of each data processing channel, the valid data other than invalid data and non-valuable data (that is, the target valid data) may be integrated as truly valid data to cut out invalid data and non-valuable data as much as possible. For the integration method, reference can be made to the relevant description in the foregoing embodiments, which will not be repeated here. Compared with the foregoing integration process, the only difference here is that non-valuable data is excluded from the valid data to avoid integrating non-valuable data as valid data, which further simplifies the valid data pairs of each functional layer, and correspondingly further improves the data calculation performance of each functional layer.

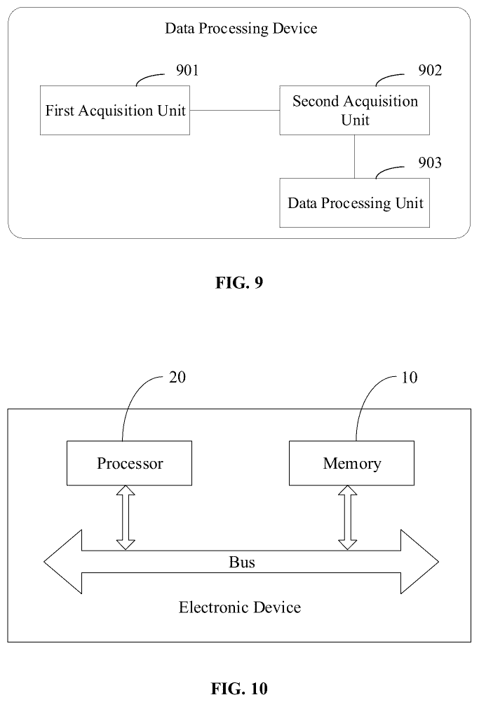

Corresponding to the above data processing method, an embodiment of the present disclosure also provides a data processing device. FIG. 9 is a hardware structural diagram of an electronic device suitable for the text recognition method according to an embodiment of the present disclosure. As shown in FIG. 9, the data processing device at least includes a first acquisition device 901, a second acquisition device 902, and a data processing device 903.

In some embodiments, the first acquisition device 901 may be configured to obtain at least one first target data object including first target data, the first target data in each first target data object at least including all valid data corresponding to each data processing channel; each first target object corresponding to corresponding position information, which is used to indicate the position of second target data corresponding to the first target data; the number of the first target data objects being less than the number of data processing channels.

In some embodiments, the second acquisition device 902 may be configured to obtain the corresponding second data object from the to-be-processed data included in the second data object corresponding to each data processing channel based on the position information corresponding to the first data object.

In some embodiments, the data processing device 903 may be configured to perform data processing on the first target data and the corresponding second target data.

In some embodiments, the sparsity of each first target data object may be less than a set threshold, the sparsity being used to characterize the proportion of invalid data in the first target data object.

In some embodiments, the device may also include a generation unit. The generation unit may be configured to form the first target data object. When forming the first target data object, the generation unit may be configured to generate a corresponding first data object for each data processing channel based on the model training process, and integrate the valid data in the first data objects corresponding to each data processing channel to obtain the at least one first target data object.

In some embodiments, when integrating the valid data in the first data object corresponding to each data processing channel, the generation unit may be configured to determine invalid data and valid data in each first data object, and migrate the valid data included in some first data objects to the position of the invalid data in the first data object other than the first data objects including the valid data, the at least one first target data object including the first data object that includes at least each valid data obtained after the migration is completed.

In some embodiments, the second acquisition device 902 may be configured to, for each first target data in the first target data object, obtain the to-be-processed data corresponding to the target position in the second data object corresponding to the target data processing channel as the second target data corresponding to the first target data.

In some embodiments, the target data processing channel and the target position may be respectively the data processing channel indicated by the position information of the first target data and the corresponding position within the indicated data processing channel.

In some embodiments, the data processing device 903 may be configured to assign a corresponding available hardware processing channel to each first target data object, and use the corresponding available hardware processing channel to perform data processing on the first target data and the corresponding second target data in the corresponding first target data object. Or, the data processing device 903 may be configured to, based on a preset balancing strategy, evenly distribute the to-be-processed data pairs formed by each first target data and the corresponding second target data to different available hardware processing channels based on the quantity, and use the corresponding available hardware processing channels to perform data processing on the allocated to-be-processed data pairs.

In some embodiments, the data processing device 903 may be configured to perform data processing on the first target data and the second target data corresponding to a plurality of preset functional layers. Each functional layer may correspond to multiple data processing channels, and each functional layer may correspond to at least one to-be-processed first target data object, and a second data object on each corresponding data processing channel. Each functional layer may be connected in series.

In some embodiments, when integrating valid data in the first data object corresponding to each data processing channel, the generation unit may be configured to determine the invalid data in the first data object corresponding to the current functional layer on each data processing channel, and the non-valuable data in the valid data that is of no value to the data processing of the downstream functional layer; and migrate the target valid data included in some of the first data objects corresponding to the current functional layer to the position of invalid data and non-valuable data in the first data objects other than the first data objects in the current functional layer.

In some embodiments, the at least one first target data object corresponding to the current functional layer may include a first data object obtained after completing the migration of the current functional layer and at least including each valid data. The target valid data included in the first data object may be data other than invalid data and non-valuable data in the first data object.

In some embodiments, when determining the non-valuable data, if there is a first data object including invalid data in each first data object corresponding to the first functional layer in the plurality of functional layers, the generation unit may be configured to determine the to-be-processed data whose corresponding data processing results will be invalidated by the invalid data from each first data object corresponding to the upstream functional layer of the first functional layer as non-valuable data.

In some embodiments, the generation unit may be further configured to determine whether the data in the first data object corresponding to each data processing channel meets the sparsification condition, if so, integrate the valid data in the first data objects corresponding to each data processing channel to obtain the at least one first target data object.

Since the data processing device of the present disclosure corresponds to the data processing method embodiments of the present disclosure, the description of the data processing device can be simple. For the related part, reference can be made to method embodiments, which are not repeated here.

Embodiments of the present disclosure also provide an electronic device. The structure of the electronic device, as shown in FIG. 10, at least includes a memory 10 and a processor 20.

The memory 10 can be used to store a computer instruction set. The computer instruction set in memory 10 can be implemented as a computer program.

The processor 20 can be configured to execute the computer instruction set to implement the data processing method described in the foregoing embodiments.

The processor 20 can be a central processing unit (CPU), an application-specific integrated circuit (ASIC), a digital signal processor (DSP), a dedicated integrated circuit (ASIC), a field-programmable gate array (FPGA), a neural network processor (NPU), a deep learning processor (DPU), or another programmable logic device.

The electronic device may include a display device and/or a display interface that can be connected to an external display device.

In some embodiments, the electronic device may also include a camera assembly, and/or may be connected to an external camera assembly.

In addition, the electronic apparatus can also include components such as a communication interface and a communication bus. The memory, the processor, and the communication interface can communicate with each other through the communication bus.

The communication interface can be configured for communication between the electronic apparatus and another apparatus. The communication bus can be a Peripheral Component Interconnect (PCI) bus or an Extended Industry Standard Architecture (EISA) bus, etc. The communication bus can be classified as an address bus, a data bus, a control bus, etc.

Embodiments of the present disclosure are described in a progressive manner. Each embodiment focuses on the differences from other embodiments. The common and similar parts among embodiments can be referred to each other.

To facilitate the description, the above system or device is described in various modules or units based on the functions. In the present disclosure, the functions of the units can be implemented in a same or a plurality of pieces of software and/or hardware.

According to the description of embodiments of the present disclosure, those skilled in the art can clearly understand that the present disclosure can be implemented by software and a necessary general hardware platform. Based on this understanding, the essence of the technical solution of the present disclosure or the part of the technical solution of the present disclosure contributing to the existing technology can be embodied in the form of a software product. The computer software product can be stored in a storage medium such as ROM/RAM, disk, CD, etc., including a plurality of instructions used to cause a computer apparatus (e.g., a personal computer, a server, or a network apparatus) to execute the method of embodiments or certain parts of embodiments of the present disclosure.

In the specification, terms such as first, second, third, and fourth are merely used to distinguish one entity or operation from another entity or operation and do not necessarily imply any actual relationship or order between these entities or operations. Moreover, the terms “including,” “comprising,” or any other variations thereof are intended to encompass non-exclusive inclusion. Thus, a process, a method, an article, or an apparatus comprising a series of elements includes not only those elements but also other elements that are not explicitly listed but are inherent to the process, method, article, or apparatus. Unless otherwise specified, the phrase “including a . . . ” does not exclude the existence of additional identical elements in the process, method, article, or apparatus comprising the elements.

Some embodiments of the present disclosure are described above. Those skilled in the art can make various modifications and improvements without departing from the principles of the present disclosure. These modifications and improvements are within the scope of the present disclosure.

What is claimed is:

1. A data processing method comprising:
obtaining at least one first target data object including first target data, the first target data in each first target data object at least including all valid data corresponding to each data processing channel, each first target data corresponding to corresponding position information, the position information indicating a position of second target data corresponding to the first target data, a number of first target data objects being less than a number of data processing channels;
obtaining the corresponding second target data from to-be-processed data included in a second data object corresponding to each data processing channel based on the position information corresponding to the first target data; and
performing data processing on the first target data and the corresponding second target data.

2. The method of claim 1, wherein:
sparsity of each first target data object is less than a set threshold, the sparsity characterizing a proportion of invalid data in the first target data object.

3. The method of claim 1, wherein a method of forming the first target data object includes:
generating a corresponding first data object for each data processing channel based on a model training process; and
integrating the valid data in the first data objects corresponding to each data processing channel to obtain the at least one first target data object.

4. The method of claim 3, wherein integrating the valid data in the first data objects corresponding to each data processing channel includes:
determining the invalid data and valid data in each first data object; and
migrating the valid data included in some first data objects to the position of the invalid data in the first data objects other than the first data objects including the valid data, the at least one first target data object including the first data object that includes at least each valid data obtained after the migration is completed.

5. The method of claim 1, wherein obtaining the corresponding second target data from the to-be-processed data included in the second data object corresponding to each data processing channel based on the position information corresponding to the first target data includes:
for each first target data in the first target data object, obtaining the to-be-processed data corresponding to a target position in the second data object corresponding to a target data processing channel as the second target data corresponding to the first target data, the target data processing channel and the target position being respectively the data processing channel indicated by the position information of the first target data and the corresponding position within the indicated data processing channel.

6. The method of claim 1, wherein performing data processing on the first target data and the corresponding second target data includes:
assigning a corresponding available hardware processing channel to each first target data object, and using the corresponding available hardware processing channel to perform data processing on the first target data and the corresponding second target data in the corresponding first target data object; or
based on a balancing strategy, evenly distributing to-be-processed data pairs formed by each first target data and the corresponding second target data to different available hardware processing channels based on quantity, and using the corresponding available hardware processing channels to perform data processing on the assigned to-be-processed data pairs.

7. The method of claim 3 further comprising:
performing data processing on the first target data and the second target data corresponding to a plurality of preset functional layers, each functional layer corresponding to multiple data processing channels, and corresponding to at least one to-be-processed first target data object, and the second data object on each corresponding data processing channel, each functional layer being connected in series, wherein:
integrating the valid data in the first data object corresponding to each of the data processing channels includes:
determining the invalid data in the first data object corresponding to a current functional layer on each data processing channel, and non-valuable data in the valid data that is of no value to the data processing of a downstream functional layer;
migrating target valid data included in some of the first data objects corresponding to the current functional layer to the position of invalid data and non-valuable data in the first data objects other than the first data objects in the current functional layer;
the at least one first target data object corresponding to the current functional layer including a first data object obtained after completing the migration of the current functional layer and at least including each valid data; the target valid data included in the first data object being data other than the invalid data and non-valuable data in the first data object.

8. The method of claim 7, wherein a method of determining the non-valuable data includes:
if the first data object includes the invalid data in each first data object corresponding to a first functional layer in the plurality of functional layers, determining, from each first data object corresponding to an upstream functional layer of the first functional layer, a corresponding data processing result to be invalidated by the to-be-processed as the non-valuable data.

9. The method of claim 3, wherein the method of forming the first target data object further comprising:
determining whether the data in the first data object corresponding to each data processing channel meets a sparsification condition, if the sparsification condition is met, triggering the integration of valid data in the first data object corresponding to each data processing channel to obtain the at least first target data object.

10. A data processing device comprising:
a first acquisition device, the acquisition device being configured to obtain at least one first target data object including first target data, the first target data in each first target data object at least including all valid data corresponding to each data processing channel, each first target data corresponding to corresponding position information, the position information being used to indicate a position of second target data corresponding to the first target data, a number of first target data objects being less than a number of data processing channels
a second acquisition device, the second device being configured to obtain the corresponding second target data from to-be-processed data included in a second data object corresponding to each data processing channel based on the position information corresponding to the first target data; and
a data processing device, the data processing device being configured to perform data processing on the first target data and the corresponding second target data.

11. The device of claim 10, wherein:
sparsity of each first target data object is less than a set threshold, the sparsity characterizing a proportion of invalid data in the first target data object.

12. The device of claim 10, wherein the second acquisition device is configured to:
for each first target data in the first target data object, obtain the to-be-processed data corresponding to a target position in the second data object corresponding to a target data processing channel as the second target data corresponding to the first target data, the target data processing channel and the target position being respectively the data processing channel indicated by the position information of the first target data and the corresponding position within the indicated data processing channel.

13. The device of claim 10, wherein the data processing device is configured to:
assign a corresponding available hardware processing channel to each first target data object, and use the corresponding available hardware processing channel to perform data processing on the first target data and the corresponding second target data in the corresponding first target data object; or
based on a balancing strategy, evenly distribute to-be-processed data pairs formed by each first target data and the corresponding second target data to different available hardware processing channels based on quantity, and use the corresponding available hardware processing channels to perform data processing on the assigned to-be-processed data pairs.

14. The device of claim 10, wherein the data processing device is further configured to:
perform data processing on the first target data and the second target data corresponding to a plurality of preset functional layers, each functional layer corresponding to multiple data processing channels, and corresponding to at least one to-be-processed first target data object, and the second data object on each corresponding data processing channel, each functional layer being connected in series.

15. An electronic device comprising:
a processor; and
a memory storing program instructions for, when executed by the processor, performing a data processing method, the method comprising:
obtaining at least one first target data object including first target data, the first target data in each first target data object at least including all valid data corresponding to each data processing channel, each first target data corresponding to corresponding position information, the position information indicating a position of second target data corresponding to the first target data, a number of first target data objects being less than a number of data processing channels;
obtaining the corresponding second target data from to-be-processed data included in a second data object corresponding to each data processing channel based on the position information corresponding to the first target data; and
performing data processing on the first target data and the corresponding second target data.

16. The electronic device of claim 15, wherein:
sparsity of each first target data object is less than a set threshold, the sparsity characterizing a proportion of invalid data in the first target data object.

17. The electronic device of claim 15, wherein a method of forming the first target data object includes:
generating a corresponding first data object for each data processing channel based on a model training process; and
integrating the valid data in the first data objects corresponding to each data processing channel to obtain the at least one first target data object.

18. The electronic device of claim 17, wherein integrating the valid data in the first data objects corresponding to each data processing channel includes:
determining the invalid data and valid data in each first data object; and
migrating the valid data included in some first data objects to the position of the invalid data in the first data objects other than the first data objects including the valid data, the at least one first target data object including the first data object that includes at least each valid data obtained after the migration is completed.

19. The electronic device of claim 15, wherein obtaining the corresponding second target data from the to-be-processed data included in the second data object corresponding to each data processing channel based on the position information corresponding to the first target data includes:
for each first target data in the first target data object, obtaining the to-be-processed data corresponding to a target position in the second data object corresponding to a target data processing channel as the second target data corresponding to the first target data, the target data processing channel and the target position being respectively the data processing channel indicated by the position information of the first target data and the corresponding position within the indicated data processing channel.

20. The electronic device of claim 15, wherein performing data processing on the first target data and the corresponding second target data includes:
assigning a corresponding available hardware processing channel to each first target data object, and using the corresponding available hardware processing channel to perform data processing on the first target data and the corresponding second target data in the corresponding first target data object; or
based on a balancing strategy, evenly distributing to-be-processed data pairs formed by each first target data and the corresponding second target data to different available hardware processing channels based on quantity, and using the corresponding available hardware processing channels to perform data processing on the assigned to-be-processed data pairs.
